(19) United States
(12) Patent Application Publication
(10) Pub. No.: US 2023/0287920 A1
(43) Pub. Date: Sep. 14, 2023

(54) SCREW, USE, METHOD AND SYSTEM

(71) Applicant: Arnold Umformtechnik GmbH & Co. KG, Forchtenberg-Ernsbach (DE)

(72) Inventors: Bernd WERTHWEIN, Sindringen (DE); Thomas JAKOB, Ahnatal (DE)

(21) Appl. No.: 18/006,276

(22) PCT Filed: Jul. 22, 2021
(86) PCT No.: PCT/EP2021/070531

§ 371 Date: Jan. 20, 2023

(30) Foreign Application Priority Data
Jul. 23, 2020 (DE) 10 2020 209 328.8

(51) Int. Cl. F16B 25/00; B23P 19/06

(52) U.S. Cl. CPC F16B 25/0057; F16B 25/0078; F16B 25/0084; B23P 19/065

(57) ABSTRACT

A screw having a screw head and a screw shank, wherein the screw head is provided with a driving formation and the screw shank is provided at least partially with a thread. The screw shank has a cylindrical holding portion and an end portion that narrows towards a screw end, and in the holding portion the thread is formed as a standard thread. The holding portion has a circular cross section, and the end portion narrows starting from the holding portion. The end portion is provided with at least two thread turns which are formed as a forming thread, and the end portion has a polylobular cross section and the screw shank is hardened in the holding portion and in the end portion.

The invention relates to a screw having a screw head and a screw shaft, wherein the screw head is provided with a drive formation and the screw shaft is at least partially provided with a thread, wherein the screw shaft has a cylindrical retention portion and an end portion which tapers toward a screw end, wherein in the retention portion the thread is in the form of a standard thread, in particular a metric thread, and wherein the retention portion has a circular cross section. The invention also relates to the use of a screw according to the invention. The invention further relates to a system and a method for screwing a screw according to the invention.

On the one hand, screws for screwing into internal threads which are provided are known. Screws have a screw head and a screw shaft, wherein the screw head is provided with a drive formation and the screw shaft is at least partially provided with a thread, wherein the screw shaft has a cylindrical retention portion and an end portion which tapers toward a screw end, wherein in the retention portion the thread is in the form of a standard thread, in particular a metric thread. The tapering end portion facilitates the introduction into a provided internal thread.

On the other hand, so-called thread-forming screws are known. Thread-forming screws are used to form a thread in a provided hole, for example, a through-hole in a metal sheet. To this end, a tapering end portion of the screw is provided with a forming thread or grooving thread. A retention thread which is optimized with regard to optimum retention of the screw in the workpiece is then provided in the cylindrical retention portion.

With the invention, a screw, use of a screw, a system for screwing a screw and a method for screwing a screw are intended to be improved.

To this end, there are provided according to the invention a screw having the features of claim 1, use of a screw according to the invention having the features of claim 14, a system for screwing a screw according to the invention having the features of claim 15 and a method having the features of claim 16.

The invention is based on the recognition that it is surprisingly possible to screw in the same screws both in holes with an internal thread provided and in holes without any internal thread. Surprising advantages are thereby afforded with respect to stock-keeping, documentation and process reliability of screwing-in processes. Particularly, there is provided to this end a screw which is suitable as a thread-forming screw and which has an end portion which tapers from the retention portion, wherein the end portion is provided with at least two thread turns which are in the form of the forming thread, wherein the end portion has at least in the region of the forming thread a polylobulated cross section and wherein the screw shaft is hardened in the retention portion and in the end portion. As a result of the hardened end portion which is provided with a polylobulated cross section and which has at least two thread turns of a forming thread and which tapers from the cylindrical retention portion, the screw is suitable as a thread-forming screw and it is possible to form a thread into a provided hole without any internal thread with this screw. In the context of the invention, it is advantageous if from two to six thread turns of a forming thread are provided. Since the thread is in the form of a standard thread in the cylindrical retention portion which has a circular cross section, the screw can also be screwed into a provided standard internal thread. Regardless of whether a hole does not have an internal thread and consequently a thread has to be formed or grooved with the screw or whether a hole has an internal thread, therefore, the same screws can be used.

Initially, this makes stock-keeping easier because the same screws are screwed both in holes with an internal thread and in holes without an internal thread. A disadvantage in this case is naturally that the screws according to the invention are more expensive to produce than conventional standard threaded screws. Surprisingly, however, these cost disadvantages can be compensated for and even over-compensated for in that a simplified stock-keeping is possible, in that the screws according to the invention can be produced in very large batch quantities and in that the documentation necessary for screwing-in processes is simplified and particularly also the process reliability during screwing-in is substantially improved. This is because, by using the same screws for screwing into holes without an internal thread and holes with an internal thread, confusion is avoided. Screws are generally comparatively small components and conventional screws with standard threads may differ significantly from a technical point of view, but they differ only slightly in terms of appearance from thread-forming screws for forming or grooving threads. Occurrences of confusion are therefore possible because both screws have very similar external dimensions. This can even lead to the situation that an automatic screwing-in machine provided per se for thread-forming screws does not recognize that it is filled with conventional screws with standard threads. Only during the production process, that is to say, during screwing-in, does the error possibly become evident that the screws with a standard thread are snapping when forming a thread. However, it would be substantially more critical if the screws did not break off when the thread is formed and a workpiece in which screws with inadequate strength have been fitted is then thereby produced. The documentation of a screwing-in process is also simplified because the same screws are always used. The process reliability is substantially improved in that confusion involving different screws cannot occur any longer.

In a further development of the invention, the end portion is in the form of an ogive-like tip, wherein the ogive-like tip is particularly flattened or rounded.

The end portion is preferably in the form of an ogive, in other words a pointed arch, the tip of which can be flattened or rounded. The transition from the ogive tip to the cylindrical retention portion can be carried out in this case tangentially, that is to say, without any visible or perceptible edge, or also in such a manner that an edge is formed in the contour of the screw and consequently the ogive tip does not run tangentially into the cylindrical retention portion.

In a further development of the invention, the end portion is in the form of a frustoconical portion, particularly with a rounded end.

In a further development of the invention, the end portion ends at an end face.

In the screw according to the invention, it is not necessary to construct a tip because the screw according to the invention is provided to be screwed into provided holes in a workpiece.

In a further development of the invention, a diameter of the end face when viewed perpendicularly to the longitudinal screw axis is between 70% and 80%, in particular 75%, of the diameter of the retention portion.

With such dimensions, in particular for the preferably used ogive-like zone, on the one hand, a simplified location of the hole is enabled during automatic processing of the screws according to the invention and also the tapping of a thread can be carried out in a reliable and operationally safe manner.

In a further development of the invention, the end portion has a rounded searching tip.

In this manner, the screw can be introduced into provided holes in a very simple manner even if, for example, component tolerances may be anticipated.

In a further development of the invention, the searching tip is constructed without a thread.

This makes it easier to locate holes with tolerances.

In a further development of the invention, the searching tip has a circular cross section.

This also facilitates the introduction of the screw into already-present holes. For example, the first turns can be used to position the screw correctly even before the forming thread is engaged relative to a smooth hole or a hole with a thread provided.

In a further development of the invention, the end portion has a polylobulated cross section exclusively in the region of the forming thread.

In this manner, a thread can be formed so that the screw is also suitable for smooth holes without any internal thread. As a result of the retention portion, however, very high extraction forces are reached. The searching portion which is also round in cross section, that is to say, the region which is located between the forming thread and the free end of the screw, facilitates introduction of the screw into provided holes with or without internal threads.

In a further development of the invention, the forming thread is in the form of a round thread in the end portion.

In this manner, the forming of a thread is facilitated as is the positioning of the screw. In the case of the round thread, both the thread tip and the thread bases or thread valleys can be formed in a round manner, both the thread turns and the core therefore have a round profile.

In a further development of the invention, the end portion has additional thread turns which are in the form of round threads in addition to the forming thread.

When the screw is screwed into a provided internal thread, the location of the internal thread is thereby made easier. The round thread can also have rounded thread tips and rounded bases in this case so that a round profile is present on the thread turns and in the core.

In a further development of the invention, the standard thread is in the form of a trapezoidal thread in the retention portion.

In this manner, very good extraction forces are achieved. In other words, the retention thread is in the form of a tip thread with flattened bases and tips. The angle between the thread flanks is typically 60°.

In a further development of the invention, the thread has, when viewed from the side, on the screw shaft a continuous notional generating curve as far as the free end of the screw shaft.

In other words, the forming thread does not project beyond the generating curve but instead, also in the region of the radially furthest-projecting regions of the forming thread which is configured with a polylobulated cross section, the thread tip simply touches the continuous generating curve and does not project beyond it.

In a further development of the invention, at least the end portion is further partially, in particular inductively, hardened.

As a result of partial and in particular inductive hardening, it is possible to construct at least the end portion so that it withstands the mechanical and thermal loads when a thread is formed. The greatest mechanical and thermal loads occur in the region of the end portion, therefore it is generally simply necessary to harden the end portion in an inductive, partial manner. In particular, only a region of the end portion starting from the surface extending as far as a predefined depth is further hardened partially. It is not necessary to additionally partially harden the complete cross section of the end portion because the retention portion is also already hardened according to the invention.

In a further development of the invention, the screw is hardened to the strength classes 8.8, 10.9, 12.9 or up to the ultra-high-strength range.

These strength classes have been found to be extremely advantageous for the screw according to the invention. Furthermore, the thread-forming end portion can be partially additionally hardened. The hardening method for the screws according to the invention can be bainitic or case-hardened with subsequent annealing. In particular, a bainite structure has a high strength and a very high toughness. Bainite structure is produced in carbon-containing steel by a special cooling in a salt bath. Bainite structure has been found to be extremely advantageous for the screw according to the invention.

In a further development of the invention, a tensile strength of the screw is at least 800 N/mm².

For example, the screw according to the invention is in the form of a so-called 8.8 screw, preferably the screw according to the invention is in the form of a 10.9 screw.

In a further development of the invention, a 0.2% permanent elongation limit of the screw is at least 640 N/mm², in particular at least 900 N/mm², in particular at least 1040 N/mm².

For example, the screw is constructed with a strength 8.8 or a greater strength, in particular up to the ultra-high-strength range.

In a further development of the invention, at least the last complete thread turn of the forming thread is constructed before the end of the end portion at the transition to the retention portion with respect to the thread dimensions in the same manner as the standard thread in the retention portion.

With the exception of the different cross section because the retention portion has a circular cross section and the end portion has a polylobulated cross section, the last thread turn of the forming thread corresponds with respect to the thread dimensions, that is to say, with respect to the external diameter and the core diameter, to the standard thread in the retention portion. Unlike conventional forming threads which have a slightly greater diameter than standard threads, in the screw according to the invention the forming thread is not configured with an excess dimension with respect to the standard thread in the retention portion. This has the very substantial advantage that the screw according to the invention can be screwed in completely without any problem into provided internal threads which correspond to the standard. It has surprisingly been found that, in spite of the forming thread not being produced with an excess dimension with respect to the standard thread in the retention portion, the screw according to the invention can also be screwed into holes without any internal thread, in which therefore a thread must initially be formed by means of the forming thread. The maximum screwing-in torques which are predetermined by the material and the dimensions can be complied with. The thread dimensions relate in this instance to the external diameter and the core diameter and in particular the flank diameter, the pitch of the thread and the flank angle. As a result of the polylobulated cross section of the end portion, the external diameter, the core diameter and the flank diameter must be measured as the greatest diameter of the last thread turn of the forming thread. Only when the polylobulated cross section is configured to be a curve of constant width, i.e. the crosssection has a constant width when measured perpendicular to its outer periphery, can the external diameter, the core diameter and the flank diameter of the last thread turn of the forming thread be measured independently of the angle position. The standard thread in the retention portion can be, for example, in the form of a metric thread or imperial thread. In the case of a metric thread M5, the external diameter of the standard thread in the retention portion is between 4.790 mm and 5.0 mm, cf. DIN 13-20: 2000-08/M5-4H-6G-6E. A conventional forming thread for forming a metric M5 thread would usually, with an external diameter or a circumcircle around a polygonal cross section at least with a portion of the tolerance range, be greater than the nominal dimension of the external diameter, that is to say, greater than 5.0 mm. According to the invention, however, the forming thread or at least the last thread turn of the forming thread at the transition between the end portion and the retention portion is configured with an external diameter corresponding to the standard thread, that is to say, between 4.790 mm and 5.0 mm. 4.790 mm corresponds to the minimum dimension for M5 screws according to the tolerance class 6E.

The invention also relates to the use of a screw according to the invention in a first application as a thread-forming screw or in a second application as a screw for being screwed into provided internal threads.

Therefore, by the screws according to the invention being able to be used, on the one hand, as thread-forming screws and, on the other hand, as screws for being screwed into provided internal threads, the same screws can be used for different applications. This facilitates stock-keeping, allows great batch numbers of the screws, facilitates the documentation of the screwing-in process and particularly avoids errors during the production of workpieces which may occur by different screws becoming confused. By using according to the invention the screws according to the invention both as thread-forming screws and as screws for being screwed into provided internal threads, therefore, possibly safety-relevant errors during the production of workpieces can be avoided and the disadvantage of the higher production costs of the screws according to the invention with respect to conventional screws with standard threads can be compensated for or even over-compensated for.

With the invention, a maximum screwing-in torque for a screw according to the invention can be selected, wherein initially it is tested whether or not an internal thread is present in a provided hole in one or more workpieces, and then, if an internal thread is present, a first maximum screwing-in torque is selected and then, if no internal thread is present, a second maximum screwing-in torque is selected, wherein the first screwing-in torque is smaller than the second screwing-in torque. In this manner, the screws according to the invention can be used both to form an internal thread and to screw into a provided internal thread. By the maximum screwing-in torque being selected to be smaller during screwing into a provided internal thread than when a thread is formed, it can reliably be established whether the screw will jam when it is screwed into a provided internal thread or other irregularities will occur. With the invention, screwing-in torques can also be reduced in a thread-forming screwing action, wherein this can also be applied to a screw connection with a provided nut thread. In the case of a provided nut thread which is preferably metric, during the screwing-in action with a metric screw only a very small screwing-in torque occurs. During the screwing-in action of conventional thread-forming screws into a provided nut thread, increased screwing-in torques can occur because the conventional thread-forming screws have an excess dimension of the external diameter over the complete thread or at least over a portion of the thread. With the screw according to the invention, therefore, the screwing-in torque can be reduced. Generally, there is the risk of cross-threading when a thread-forming screw is screwed into a provided nut thread, in other words the risk of forming a second thread turn, whereby the nut thread becomes damaged or destroyed. The risk of cross-threading is caused by the forming zone in the thread-forming screw. If a thread-forming screw is screwed into a provided thread, it cannot be distinguished in practice if increased screwing-in torques occur whether they occur as a result of cross-threading or as a result of an excess dimension of the thread-forming screw and therefore as a result of the thread being subsequently formed. The screw according to the invention ensures that, when the screw is inserted directly into the provided nut thread, therefore, in other words, the nut thread has been located and no cross-threading occurs, the screwing-in torques are at an extremely low level and are generally close to zero. It is thereby possible to detect with the screw according to the invention potentially defective screwing arrangements in the event of cross-threading because the cross-threading is associated with increased screwing-in torques. The process safety using the screw according to the invention is thereby substantially greater. It is thereby possible to make a significant contribution to quality improvement in the case of assembly of thread-forming screws in provided, preferably metric, nut threads. The strategy of reducing the parts diversity by using the universal thread-forming screw according to the invention both for thread-forming screwing arrangements and for screwing arrangements in provided threads can thereby be implemented substantially better in practice.

The problem addressed by the invention is also solved by a system for screwing in a screw according to the invention, wherein means are provided for establishing whether or not a provided hole has an internal thread, and wherein adjustment means are provided in order to bring about the screwing-in of the screw with a different maximum screwing-in torque depending on whether or not a provided hole has an internal thread.

The problem addressed by the invention is also solved by a method for screwing in a screw according to the invention, wherein the steps of detecting a screwing-in torque during the screwing-in action into a provided nut thread and detecting an incorrect screwing arrangement if the screwing-in torque exceeds a predefined value are provided.

Unlike conventional self-tapping screws, in the screws according to the invention it can be distinguished whether the screw is being correctly screwed into a provided internal thread or whether so-called cross-threading is occurring and, therefore, the screw is cutting itself an additional thread in the already-provided thread. In the case of conventional thread-forming screws, the screwing-in torque is very high when screwing into provided internal threads because, for example, the external diameter of conventional thread-forming screws is greater than the external diameter of screws which are provided for screwing into provided internal threads. For this reason, in conventional thread-forming screws it is impossible to distinguish, or in any case it is not reliably possible to distinguish, between the correct screwing-in action into a provided internal thread and the case of cross-threading. The screws according to the invention can now be screwed in with a comparatively small screwing-in torque into a provided internal thread. In the event of cross-threading, this becomes evident as a substantially greater screwing-in torque, for example, a screwing-in torque which is increased up to 10-fold with respect to correct screwing-in. This can be captured and detected and thereby an incorrect screwing arrangement can be identified and, where applicable, the screwing arrangement can then be repaired.

Additional features and advantages of the invention will be appreciated from the claims and the following description of a preferred embodiment of the invention in connection with the drawings. In the drawings:

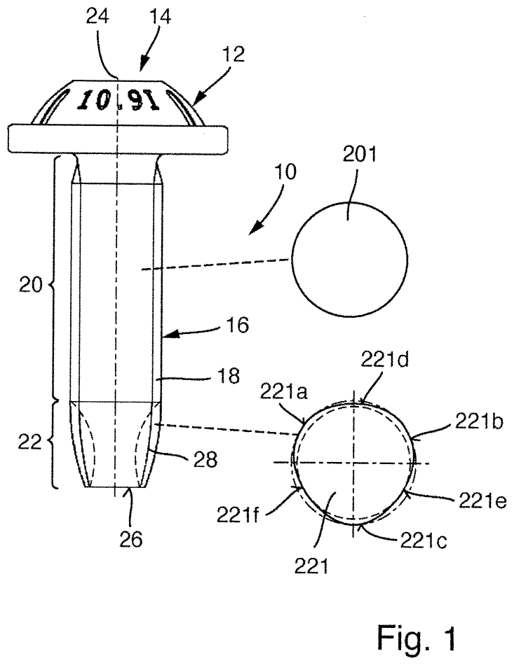

FIG. 1 shows a side view of a screw according to the invention,

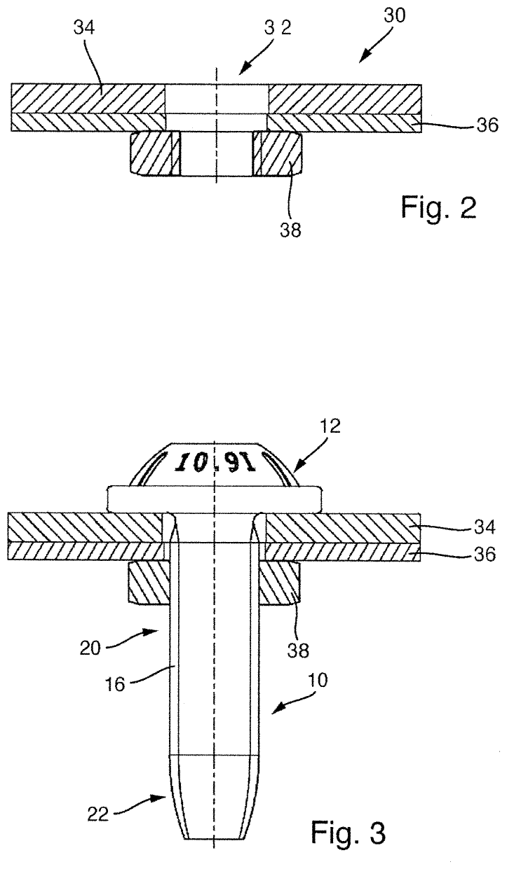

FIG. 2 shows a first workpiece with a provided hole with a partial internal thread,

FIG. 3 shows the screw of FIG. 1 in the state screwed into the workpiece of FIG. 2,

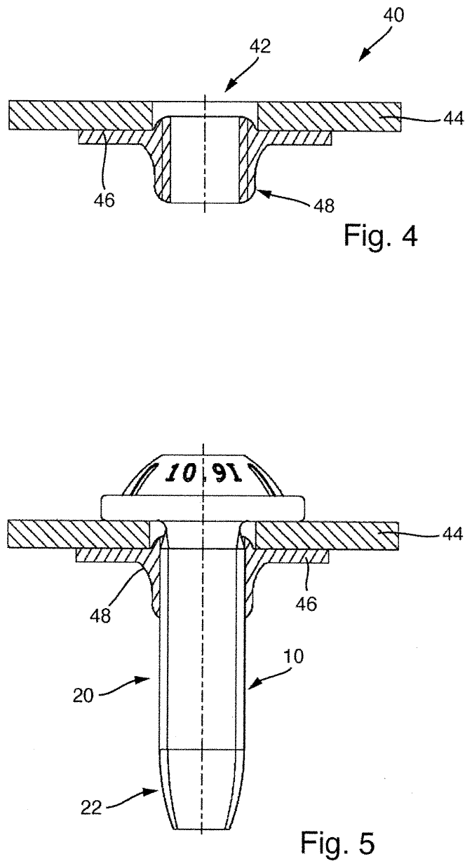

FIG. 4 shows an additional workpiece with a provided hole without any internal thread,

FIG. 5 shows the screw of FIG. 1 in the state screwed into the workpiece of FIG. 4,

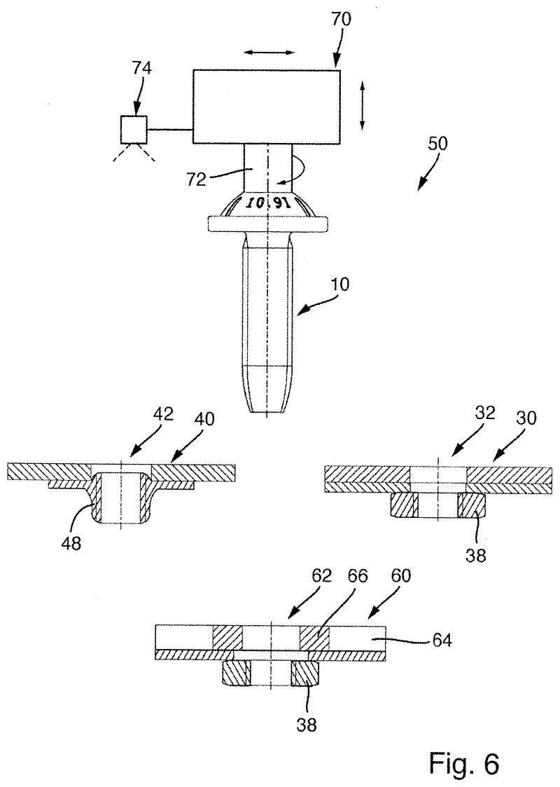

FIG. 6 shows a schematic illustration of a system according to the invention for screwing in a screw,

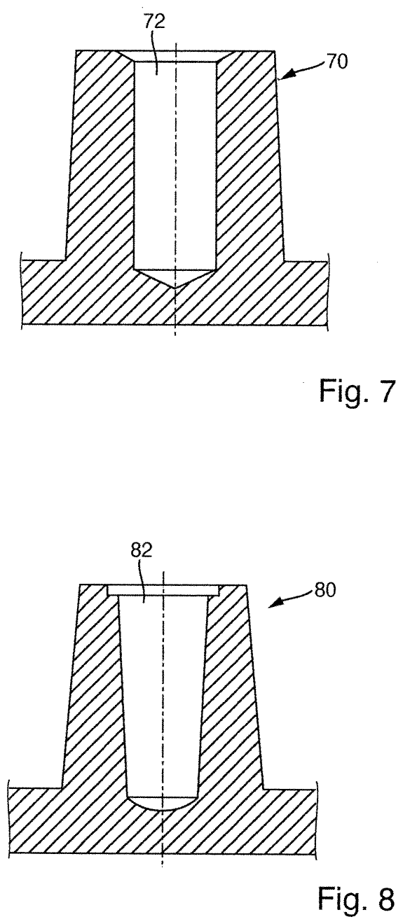

FIG. 7 shows an additional workpiece with a provided hole without any internal thread,

FIG. 8 shows an additional workpiece with a provided hole without any internal thread,

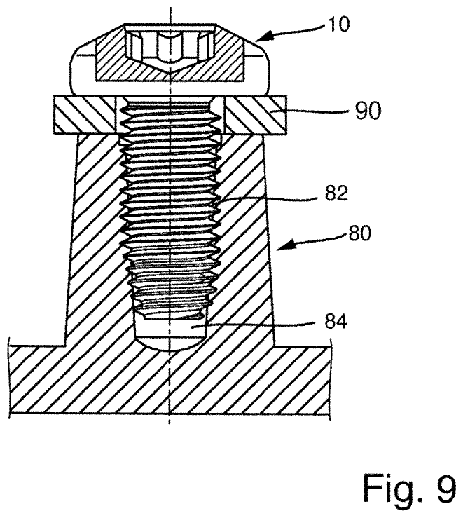

FIG. 9 shows the workpiece of FIG. 8 with a screw according to the invention screwed in,

FIG. 10 shows a partial illustration of a screw according to the invention according to an additional embodiment of the invention as an oblique rear view, wherein the screw is illustrated without a screw head,

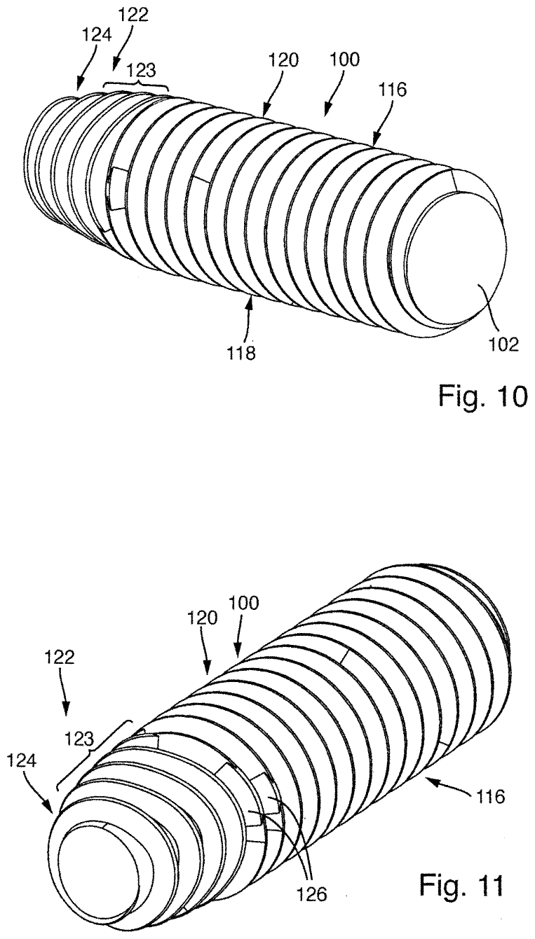

FIG. 11 shows the screw of FIG. 10 obliquely from the front,

FIG. 12 shows the screw of FIG. 10 from the front, when viewed from the free end,

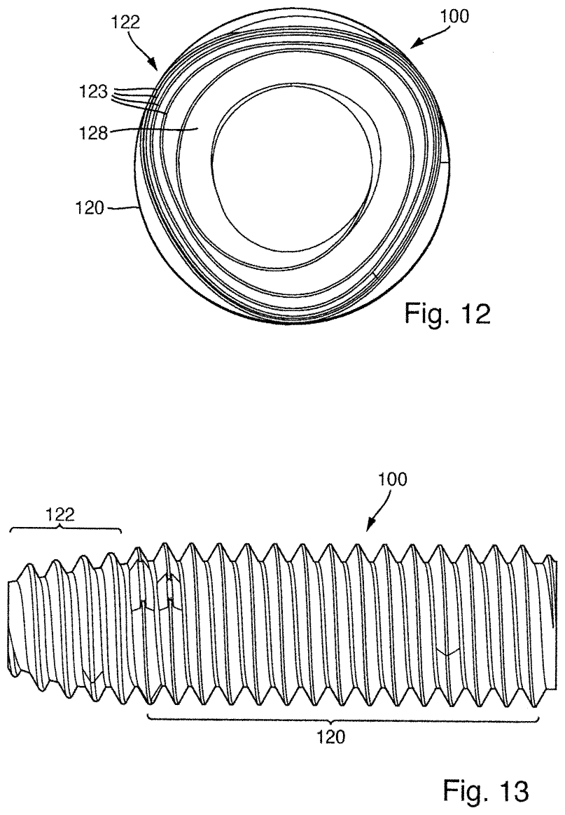

FIG. 13 shows a side view of the screw of FIG. 10,

FIG. 14 shows a partial illustration of a screw according to the invention according to an additional embodiment obliquely from the rear, wherein the screw is illustrated without a screw head,

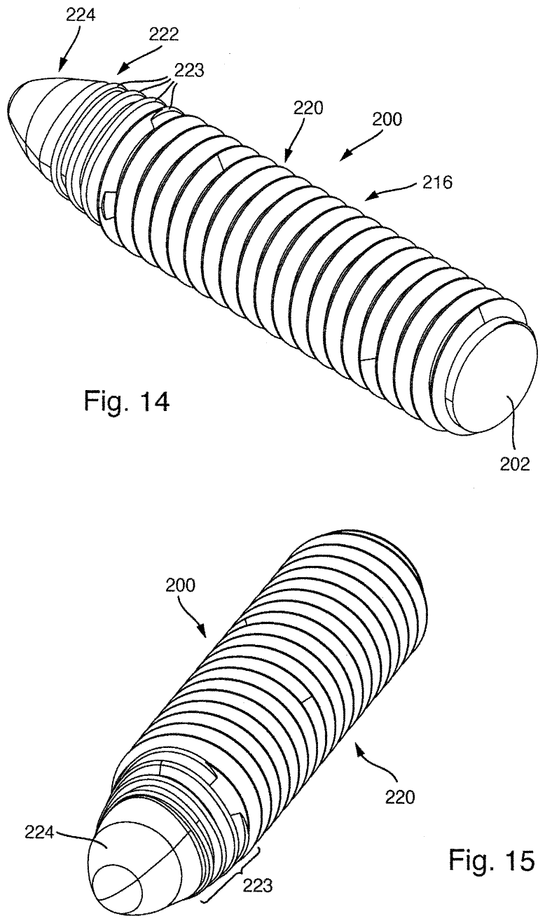

FIG. 15 shows the screw of FIG. 14 obliquely from the front,

FIG. 16 shows the screw of FIG. 14 from the front, wherein the view of the observer is directed toward the free end of the screw,

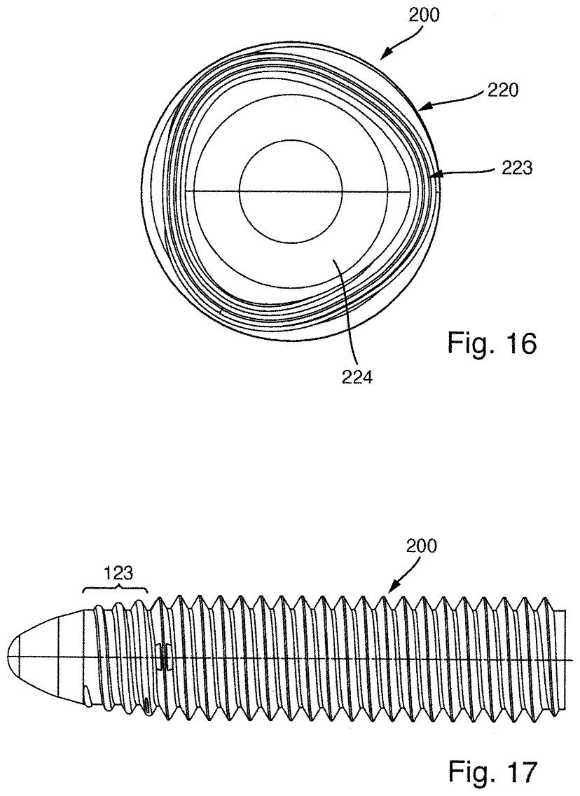

FIG. 17 shows a side view of the screw of FIG. 14 in a first rotational position about a longitudinal center axis of the screw,

FIG. 18 shows another side view of the screw, wherein the screw has been rotated about 90° about the longitudinal center axis with respect to the illustration of FIG. 17,

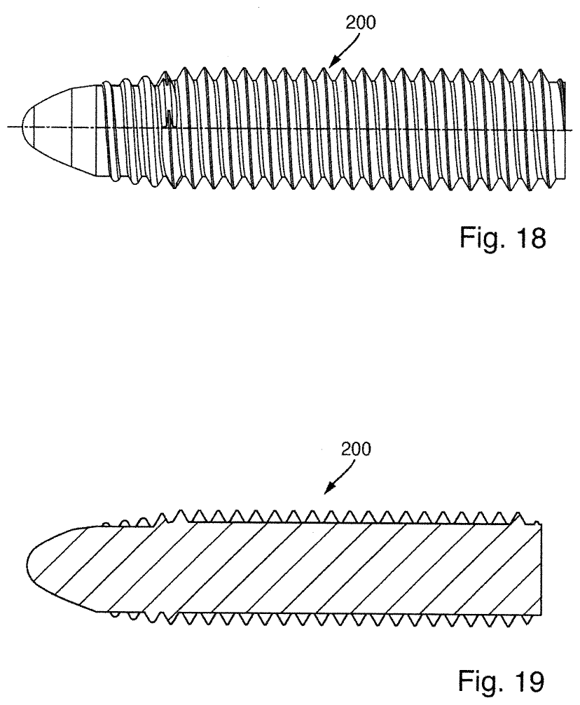

FIG. 19 shows a sectioned view of the screw of FIG. 14,

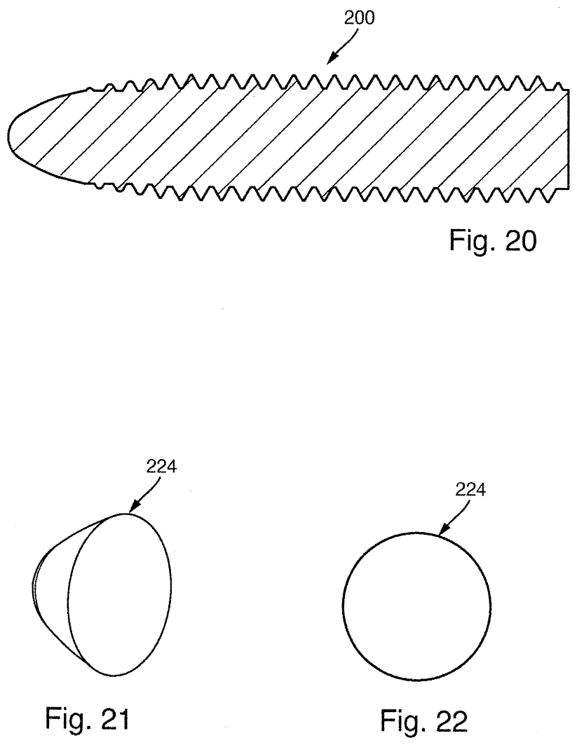

FIG. 20 shows an additional sectioned view of the screw of FIG. 14, wherein the plane of section has been rotated through 90° with respect to the illustration of FIG. 19,

FIG. 21 shows a cross section of the screw of FIG. 14 in the region of the threadless searching tip,

FIG. 22 shows the cross section of FIG. 21 from the front,

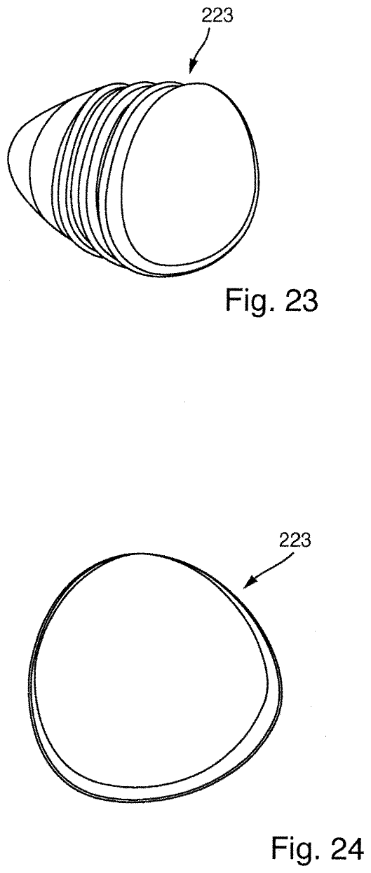

FIG. 23 shows an additional cross section of the screw of FIG. 14 in the region of the tapping thread,

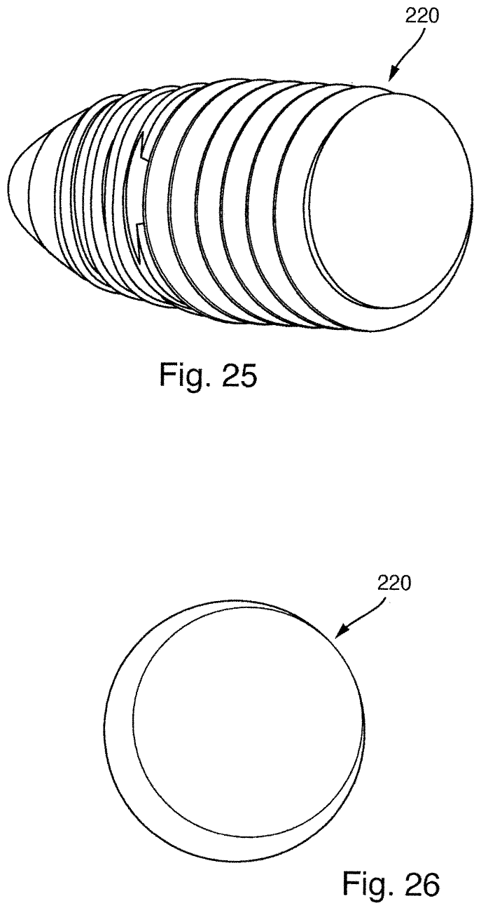

FIG. 24 shows the cross section of FIG. 23 from the front,

FIG. 25 shows an additional cross section of the screw of FIG. 14 in the region of the retention thread,

FIG. 26 shows the cross section of FIG. 25 from the front, and

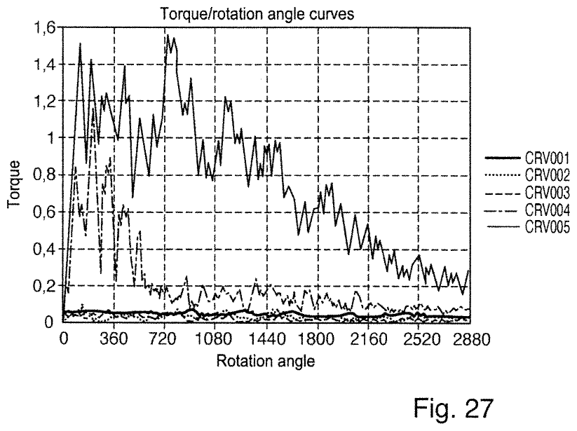

FIG. 27 shows exemplary torque/rotation angle curves when screwing in a screw according to the invention.

FIG. 1 shows a screw 10 according to the invention according to a preferred embodiment of the invention. The screw has a screw head 12 with a drive formation 14 which cannot be seen in FIG. 1 and a screw shaft 16. The screw shaft is provided with a thread 18 which is merely illustrated schematically in FIG. 1 substantially over the entire length thereof.

The screw shaft has a cylindrical retention portion 20 and an end portion 22 which adjoins the retention portion 20 in a direction away from the screw head 12. The end portion 22 tapers in a direction away from the retention portion 20.

The retention portion 20 is provided with a standard thread, for example, with a metric thread. The end portion 22 is provided with at least five thread turns of a forming thread. A thread flank height in the end portion 22 corresponds at the transition from the retention portion 20 into the end portion 22 of the thread height of the standard thread in the retention portion 20 and then decreases toward the free end of the end portion 22. The thread height at the free end of the end portion 22 is, for example, approximately 50% of the thread height of the end portion 22 at the transition to the retention portion 22.

The end portion 22 is in the form of a flattened ogive-like tip. The outer contour, which can be seen in FIG. 1, of the end portion 22 is formed by a circular arc which, on the one hand, merges tangentially into the cylindrical outer contour of the retention portion 20 and, on the other hand, terminates at the end face 26 which is arranged perpendicularly to a longitudinal center axis 24 of the screw 10. Furthermore, the end portion has a polylobulated cross section 221, which is indicated in FIG. 1 on the right beside the end portion 22, whereas the retention portion 20 has a cylindrical cross section 201. In the embodiment illustrated, the cross section 221 of the end portion 22 is provided with three rounded corners 221a, 221b, 221c and three convex-curved lateral edges 221d, 221e, 221f which connect the rounded corners to each other. This can also be referred to as trilobularity. In the embodiment illustrated, the cross section 221 is in the form of a curve of constant width. The external diameter of the cross section 221 is consequently always the same, regardless of the angular position. In the context of the invention, however, the polylobulated cross section 221 of the end portion 22 can also have an external diameter which changes depending on the angular position.

The FIGS. 10.9 can be seen at the upper side of the screw head 12. The FIGS. 10.9 indicate a screw strength. A tensile strength of the screw is at least 1000 N/mm², and a 0.2% permanent elongation limit of the screw 10 is at least 900 N/mm². In the context of the invention, such so-called 10.9 screws are the preferred embodiment.

The screw 10 is inductively hardened in the end portion 22. This is schematically indicated in FIG. 1 by means of a hardened region 28 which is indicated with a broken line 28. As a result of the inductive hardening, the complete forming thread from the surface of the end portion 22 and a region 28 which extends slightly beyond the base of the thread toward the longitudinal center axis 24 are hardened. A start region of the retention portion 20 is also inductively hardened. It can thereby be ensured that the at least five thread turns of the forming thread in the end portion 22 are completely hardened. Particularly, a completely formed thread turn must be located within the region 28 which is hardened by means of induction so that the thread in the retention portion 20 does not have to perform any forming function any more.

FIG. 2 partially shows a workpiece 30 with a hole 32. The workpiece comprises a covering metal sheet 34 which is perforated in the region of the hole 32 and a second metal sheet 36 which is provided with a press-in nut 38. The press-in nut 38 is schematically illustrated and in particular it is not illustrated how the press-in nut 38 is pressed into the metal sheet 36 and is anchored thereto. By providing the press-in nut 38, the hole 32 has a provided internal thread in the region of the press-in nut 38.

FIG. 3 shows the screw 10 of FIG. 1 in the screwed-in state. A lower side of the screw head 12 is located on the upper side of the covering metal sheet 34 and the thread 16 in the retention portion 20 engages in the internal thread of the press-in nut 38. The covering metal sheet 34 and the metal sheet 36 are consequently pretensioned with respect to each other by means of the screw 10 and the press-in nut 38.

When the screw 10 is screwed in, the tapering end portion 22 facilitates the introduction of the screw 10 into the hole 32 and also facilitates the positioning and screwing-in of the thread 16 into the internal thread of the press-in nut 38.

The screw 10 according to the invention can consequently be readily screwed into provided internal threads, in this instance into a provided internal thread of a press-in nut 38. Since the thread 16 in the retention portion 20 is in the form of a standard thread, the thread 16 engages securely in the thread of the press-in nut 38.

FIG. 4 shows a second workpiece 40 with a hole 42 which is not provided with an internal thread. The workpiece 40 again has a covering metal sheet 44 and an additional metal sheet 46 which is arranged under the covering metal sheet 44, wherein the covering metal sheet 44 and the additional metal sheet 46 are illustrated merely partially. The additional metal sheet 46 is provided with a through-hole 48 which forms an extension of the hole 42.

FIG. 5 shows the screw 10 of FIG. 1 in the state screwed into the hole 42. After the screw 10 has been positioned so that the end portion 22 is partially introduced into the hole 42 and is positioned at the upper end of the through-hole 48 in FIG. 4, the screw 10 is rotated and the forming thread in the end portion 22 is turned in the hole 42 in the through-hole 48 and in this case generates an internal thread in the through-hole 48 as a result of the thread-forming action thereof. The end portion has at least five thread turns of a forming thread which, as explained, have an increasing thread flank height from the beginning of the end portion 22 as far as the transition to the cylindrical retention portion 20. During the screwing-in action of the end portion 22 into the through-hole 48, consequently, the internal thread is shaped in the end portion 48 to such an extent that it corresponds to a standardized internal thread which corresponds to the standard thread in the cylindrical retention portion 20.

In this case, the end portion 22 which is constructed in a polylobulated manner in cross section reduces the screwing-in torque when the thread is formed because only the rounded corners of the polylobulated cross section always abut the internal wall of the through-hole 48 or only in the region of these rounded corners is an increased pressing force applied outwardly to the internal wall of the through-hole 48. As soon as the introduction portion 22 is screwed into the through-hole 48 up to the end thereof, that is to say, the transition to the retention portion 20, at least one thread turn of a completely constructed internal thread, the dimensions of which correspond to the standard and are therefore adapted to the standard thread in the retention portion 20, is available at the upper end of the through-hole 48 in FIG. 5. Consequently, the retention portion 20 can be screwed into the through-hole 48. In the state of FIG. 5, the screw 10 is completely screwed into the through-hole 48 and thereby pretensions the metal sheet 46 and the covering metal sheet 44 relative to each other.

The screw 10 according to the invention can consequently also be used to form a thread in a hole 42 without any internal thread being present.

FIG. 6 shows a system 50 for screwing screws 10 according to the invention into different workpieces 30, 40 and 60. The workpiece 30 has already been explained with reference to FIG. 2, the workpiece 40 has already been explained with reference to FIG. 4. The workpiece 60 differs from the workpiece 30 of FIG. 2 only in that, instead of the covering metal sheet, a plastics plate 64 is provided and the hole 62 is delimited by a brass sleeve 66 which is inserted into the plastics plate 64. The plastics plate 64 is arranged above the metal sheet 36 with the press-in nut 38.

The system 50 is provided to screw the same screws 10 into the different workpieces 30, 40, 60. The screw 10 is arranged on a schematically illustrated automatic screwing-in machine 70, the shaft 72 of which can be rotated in the screwing-in direction. In this case, a maximum screwing-in torque can be predetermined. The automatic screwing-in machine 70 can move in the longitudinal direction of the screw and perpendicularly thereto, in other words, therefore, in three spatial directions in order to introduce the screw 10 into one of the holes 32, 42, 62. The automatic screwing-in machine is provided with a camera 74 which is orientated toward the workpieces 30, 40, 62 and which is connected via at least one data line to a control unit (not illustrated) in the automatic screwing-in machine 70. By means of the camera 74 or another sensor which is suitable therefor, it can be established whether an internal thread is present or not in a respective hole 32, 42, 62. Regardless of whether it is established whether an internal thread is present or not, a maximum screwing-in torque is adjusted for screwing in the screw 10 by means of the automatic screwing-in machine 70.

The hole 32 of the first workpiece 30 has an internal thread in the region of the press-in nut 38. When the screw 10 is screwed into the hole 32, consequently, a first screwing-in torque is adjusted. This first screwing-in torque is, for example, selected so that it corresponds to the conventional screwing-in torque when standard threaded screws are screwed into provided internal threads.

When the screw 10 is screwed into the hole 42 which does not have an internal thread, not even in the region of the sheet metal through-hole 48, there is adjusted a second maximum screwing-in torque which is sufficient to form a thread in the through-hole 48. The second maximum screwing-in torque is greater than the first maximum screwing-in torque.

An internal thread is again present in the hole 62 of the third workpiece 60 in the region of the press-in nut 38. When the screw 10 is screwed into the hole 62, consequently, the first maximum screwing-in torque which is lower than the second maximum screwing-in torque is again adjusted.

When the system 50 according to the invention is used to screw identical screws 10 into different workpieces 30, 40, 60 or into one and the same workpiece, for example, a motor vehicle body, with differently constructed holes, consequently, confusion can be avoided between different screw types because, regardless of whether a hole in which a screw is intended to be screwed has an internal thread or not, the same screws 10 are always used. The process reliability of the screwing-in process is thereby substantially improved. The documentation of the screwing-in process is also facilitated because the same screws 10 are always used.

With the system illustrated in FIG. 6, the same screws 10 can also be screwed into the workpieces 70, 80 which are illustrated in FIGS. 7 and 8. FIG. 7 shows the workpiece 70 with a drilled core hole 72 which is constructed in a cylindrical manner. The core hole 72 does not have any internal thread and the screw 10 according to the invention can be inserted into the core hole 72, wherein the screw 10 forms a thread in the wall of the core hole 72 during introduction into the core hole 72.

The workpiece 80 illustrated in FIG. 8 has a cast, conical core hole 82. The core hole 82 is configured in a frustoconical manner and consequently has at the open end thereof which is illustrated at the top in FIG. 8 a greater diameter than at the end illustrated at the bottom in FIG. 8.

FIG. 9 shows the screw 10 according to the invention in the state screwed into the core hole 82 in the workpiece 80. With the screw 10, an additional component 90 has been secured on the workpiece 80. It can be seen in FIG. 9 that the screw 10 has formed a thread into the core hole 82. The screw 10 terminates before the base of the core hole 82 in the form of a blind hole so that an intermediate space 84 is still present between the end of the screw 10 and the base of the blind hole.

FIG. 10 shows a partial oblique rear view of an additional screw 100 according to the invention. The screw 100 has a screw head which is not illustrated and which has a drive formation, for example, the screw head 12 which is illustrated in FIG. 1. For the sake of clarity, this screw head has been omitted in the illustration of FIG. 10. The screw head would be positioned on the end facing the observer in FIG. 10, that is to say, on the sectioned face 102. In the context of the invention, an additional portion of a shaft 116 of the screw 100 can also follow the sectioned face 102. The screw 100 has on the screw shaft 116 over the entire length thereof a screw thread 118 which is in the form of a standard thread in a retention portion 120, particularly a trapezoidal thread, and a round thread in an end portion 122. It can already be seen in the view of FIG. 10 that the end portion has a forming portion 123 with a polylobulated cross section, particularly a trilobulated cross section, and at the free end of the screw 120, that is to say, at the end facing away from the observer in FIG. 10, of the end portion 122 another searching portion 124 with a circular cross section. The retention portion 120 also has a circular cross section. A forming thread with a total of four thread turns is arranged in the forming portion 123.

FIG. 11 shows an oblique front view of the screw 100 of FIG. 10, wherein again the screw head has been omitted. The view of FIG. 11 shows that in the searching portion 124 the single thread turn which can be located there has a circular cross section and is in the form of a round thread. The four thread turns in the forming portion 123 are constructed on a trilobulated cross section of the shaft 116 and are also in the form of a round thread. In the retention portion 120 which follows the tapping portion 123, the standard thread which is in the form of a 60° trapezoidal thread is again constructed on a circular cross section of the shaft 116. It can be seen that in the retention portion 120 the thread has flattened thread tips. The searching portion 124 and the forming portion 123 together form the end portion 122.

In the illustration of FIG. 11, it is possible to see on the last thread turn of the forming portion 123 and the first thread turn of the retention portion 120 regions 126 in which the thread is constructed slightly differently. These regions are not configured with flattened tips, but instead rounded thread tips and are simply used to ensure a gentle transition of the trilobulated cross section of the forming thread 123 into the thread of the retention portion with a circular cross section.

FIG. 12 shows the screw 100 of FIG. 10 as a front view, wherein again the screw head has been omitted. The view in FIG. 12 is toward the end portion 122. FIG. 12 shows that the first thread turn 128 of the end portion 122 has another approximately circular cross section. Then, four thread turns of the forming thread 123 with a trilobulated cross section follow this first thread turn 128. The retention portion 120 with a standard thread with a circular cross section can be seen behind the forming thread 123. FIG. 12 clearly shows that the forming thread 123 does not project beyond the cross section of the retention thread in the retention portion 120. In other words, the regions, which are located radially furthest outward, of the forming thread 123 do not also extend beyond the contour of the retention thread in the retention portion 120.

FIG. 13 shows a side view of the screw 100 of FIG. 10, wherein the screw head has again been omitted. It can clearly be seen that in the end portion 122 the thread is in the form of a round thread with rounded thread tips. In the context of the invention, the thread bases may also be rounded. In the retention portion 120, however, the thread is in the form of a trapezoidal thread with flattened thread tips and flattened thread bases.

FIG. 14 shows an additional embodiment of a screw 200 according to the invention. The screw 200 has a screw shaft 216 and is simply illustrated partially. Specifically, a screw head which would be placed on a sectioned face 202 is not illustrated. The screw shaft 216 can also extend beyond the sectioned face 202. For example, the screw head 12 which is shown in FIG. 1 can be positioned on the sectioned face 202.

The screw 200 has a retention portion 220 and an end portion 222. The end portion 222 has four turns of a forming thread 223 and a threadless searching tip 224. The threadless searching tip 224 is rounded at its free end and gradually increases its diameter as far as the first thread turn of the forming thread. The searching tip 224 has a circular cross section. In the region of the forming thread 223, the shaft 216 has a trilobulated cross section. In the retention portion 220, the thread is in the form of a standard thread and particularly a 60° trapezoidal thread with flattened thread tips and flattened thread bases.

FIG. 15 shows the screw 200 of FIG. 14 as a front view. The circular cross section of the searching tip 224 and the trilobulated cross section of the forming thread 223 can clearly be seen. Furthermore, the circular cross section of the thread in the retention portion 220 can be seen.

FIG. 16 shows the screw 200 as a front view, wherein the screw head has again been omitted. The circular cross section of the searching tip 224, the trilobulated cross section of the thread turns of the forming thread 223 and the circular cross section of the thread in the retention portion 220 can clearly be seen. FIG. 16 shows that the thread turns of the forming thread 223 do not project beyond the contour of the retention thread in the retention portion 220.

FIG. 17 shows a side view of the screw 200 of FIG. 14 in a first rotation position about the longitudinal center axis. In the region of the forming thread 123, the thread tips are constructed in a rounded manner. Unlike the illustration in FIG. 17, the thread bases can also be constructed in a rounded manner.

FIG. 18 shows another side view of the screw 200, wherein the screw has been rotated by 90° about the longitudinal center axis with respect to the illustration of FIG. 17.

FIG. 19 shows a side view of the screw 200 and FIG. 20 shows an additional sectioned view of the screw 200, wherein the plane of section of FIG. 20 is rotated by 90° about the longitudinal center axis with respect to the plane of section of FIG. 19.

FIG. 21 shows a sectioned view of the screw 200 in the region of the searching tip 224. FIG. 22 shows the sectioned view of FIG. 21 from the front. The circular cross section of the searching tip which is constructed in a smooth manner without any thread and which is rounded at the free end thereof can clearly be seen.

FIG. 23 shows another sectioned view of the screw 200, wherein the plane of section has been placed in the region of the forming thread 223. The polylobulated cross section with three peaks, in other words, therefore, a trilobulated cross section, can clearly be seen. FIG. 24 shows the section view of FIG. 23 from the front.

FIG. 25 shows an additional sectioned view of the screw 200 in the region of the retention portion 220. The circular cross section of the screw shaft in the retention portion 220 can clearly be seen. It should also be taken into account in FIG. 26, which shows the view of FIG. 25 from the front, that the plane of section in FIG. 25 and FIG. 26 extends perpendicularly to the longitudinal center axis of the screw but the thread turns of the retention thread have a pitch. For this reason, the plane of section runs in FIG. 25 and FIG. 26, on the one hand, through a thread base and, on the other hand, through a thread tip. This is the reason for the slight deviations from a strict circular shape.

The screws 100 and 200 of FIGS. 10 to 26 are further hardened and have a bainite structure. It is thereby possible to obtain a high strength and particularly a very great toughness of the screw.

FIG. 27 shows by way of example torque/rotation angle curves during the screwing of screws according to the invention into provided threads. In this case, a screw corresponding to FIGS. 14 to 26 was used, naturally with a screw head with a drive formation. The screw according to the invention had a diameter of 6 mm and consequently an M6 thread in the retention portion. As set out, a round thread is present in the end portion 122. In the case of correct screwing into a provided M6 nut thread, a torque of not more than 0.1 Nm is produced over a rotation angle of more than 2000° in accordance with the curves CRV001, CRV002 and CRV003. The screw according to the invention can consequently be readily and rapidly screwed into a provided nut thread.

However, the two curves CRV0004 and CRV0005 show the screwing-in action into an M6 nut thread, wherein the screw was deliberately positioned obliquely in order to bring about cross-threading, that is to say, cutting of an additional thread to the already-present nut thread. It can be seen that the torque which is necessary in this case already increases within the first turn, that is to say, within the rotation angle range from 0 to 360°, to a value of substantially more than 1 Nm. The screw according to the invention therefore requires, when cross-threading occurs, at least ten times the torque which is required during correct screwing-in. With the screw according to the invention, it is thereby possible in a very simple manner to detect whether the screw has been correctly screwed into a provided thread or whether cross-threading has occurred. This can be carried out simply by detecting the torque which is necessary for screwing in and detecting predefined torque limits being exceeded. In the torque/rotation angle curves illustrated in FIG. 27, a limit value could be placed, for example, at 0.2 Nm. If the torque required when screwing in the screw according to the invention into a thread present exceeds 0.2 Nm, a so-called cross-threading is present. The component and screw must then be assessed and where applicable repaired. As already set out, in conventional thread-forming screws the torque which is necessary when screwing into a provided nut thread is in the same range of orders of magnitude both during correct screwing-in and in the event of cross-threading. A comparable detection of incorrect screwing or the occurrence of cross-threading is therefore impossible with conventional thread-forming screws.

1. A screw having a screw head and a screw shaft, wherein the screw head is provided with a drive formation and the screw shaft is at least partially provided with a thread, wherein the screw shaft has a cylindrical retention portion and an end portion which tapers toward a screw end, wherein in the retention portion the thread is in the form of a standard thread, wherein the retention portion has a circular cross section, wherein the end portion tapers from the retention portion, wherein the end portion is provided with at least two thread turns which are in the form of a forming thread, wherein the end portion has a polylobulated cross section at least in the region of the forming thread and wherein the screw shaft is hardened in the retention portion and in the end portion.

2. The screw as claimed in claim 1, wherein the end portion has a rounded searching tip.

3. The screw as claimed in claim 2, wherein the searching tip is constructed without a thread.

4. The screw as claimed in claim 2, wherein the searching tip has a circular cross section.

5. The screw as claimed in claim 1, wherein the end portion has a polylobulated cross section exclusively in the region of the forming thread.

6. The screw as claimed claim 1, wherein the forming thread is in the form of a round thread in the end portion.

7. The screw as claimed in claim 6, wherein the end portion has additional thread turns which are in the form of round threads in addition to the forming thread.

8. The screw as claimed in claim 1, wherein the standard thread is in the form of a trapezoidal thread in the retention portion.

9. The screw as claimed in claim 1, wherein the thread has, when viewed from the side, on the screw shaft a continuous notional generating curve as far as the free end of the screw shaft.

10. The screw as claimed in claim 1, wherein at least the end portion is further partially hardened.

11. The screw as claimed in claim 1, wherein a tensile strength of the screw is at least 800 N/mm², in particular at least 1040 N/mm².

12. The screw as claimed in claim 1, wherein a 0.2% permanent elongation limit of the screw is at least 640 N/mm², in particular at least 900 N/mm².

13. The screw as claimed in claim 1, wherein at least the last complete thread turn of the forming thread before the end of the end portion at the transition to the retention portion is constructed with respect to the thread dimensions in the same manner as the standard thread in the retention portion.

14. Use of a screw as claimed in claim 1 in a first application as a thread-forming screw or in a second application as a screw for being screwed into provided internal threads.

15. A system for screwing in a screw as claimed in claim 1, the system including means for establishing whether or not a provided hole has an internal thread, and, in accordance therewith, screwing in the screw with a different maximum screwing-in torque.

16. A method for screwing in a screw as claimed in claim 1, including detecting a screwing-in torque during the screwing action into a provided nut thread and detecting an incorrect screwing arrangement if the screwing-in torque exceeds a predefined value.

17. The screw as claimed in claim 1, wherein the thread comprises a metric thread.
